(19) United States
(12) Patent Application Publication
(10) Pub. No.: US 2025/0047160 A1
(43) Pub. Date: Feb. 6, 2025

(54) STATOR TERMINAL CONNECTOR WITH BAFFLE

(71) Applicant: FORD GLOBAL TECHNOLOGIES, LLC, Dearborn, MI (US)

(72) Inventors: Akash Changarankumarth Pradeepkumar, Westland, MI (US); Singar Rathnam, Farmington Hills, MI (US)

(21) Appl. No.: 18/362,494

(22) Filed: Jul. 31, 2023

(51) Int. Cl. H02K 3/50; B60L 50/51; H02K 3/24; H02K 9/19

(52) U.S. Cl. CPC H02K 3/50; B60L 50/51; H02K 3/24; H02K 9/19; B60L 2210/40

(57) ABSTRACT

A stator for an electric motor of a vehicle utilizes a molded terminal connector. The molded terminal connector also serves as a baffle to distribute cooling fluid around end windings of the stator. The molded terminal connector includes a non-conductive cylindrical portion and frame into which the electrically conductive terminals are molded. The terminals include a winding link that is electrically connected to the end windings and a power link that is electrically connected to the inverter.

### TECHNICAL FIELD

The present disclosure relates to an electric motor for an electrified vehicle powertrain. More particularly, the disclosure relates to a motor having a terminal connector with a baffle to distribute a coolant around end windings.

### BACKGROUND

An electrified vehicle includes at least one electric machine which converts electrical power into mechanical power to propel the vehicle. In many cases, the electric machine is reversible meaning that it can also be used during braking to convert kinetic energy into electrical energy for storage in a battery. One type of electric machine that is commonly used in electrified powertrains is a permanent magnet synchronous motor. A permanent magnet synchronous motor includes a stator and a rotor. The stator includes windings. Most commonly, the windings are divided into three different phases which are each supplied with AC power that is 120 degrees different in phase. Some of the electrical power is converted to heat due to electrical resistance in the windings.

### SUMMARY

A terminal connector for an electric motor, the terminal connector having a cylindrical baffle, a non-conductive frame, and a plurality of electrically conductive terminals. The non-conductive frame extends radially inwardly from a first end of the cylindrical baffle. The cylindrical baffle and the frame may be made of plastic. The electrically conductive terminals are fixed to the frame. For example, three terminals may be molded into the frame. Each of the terminals has a winding link extending toward a second end of the cylindrical baffle and a power link extending radially outwardly from the cylindrical baffle. The terminals are electrically isolated from one another. A coolant inlet port may extending from the frame to direct a liquid coolant into an interior of the cylindrical baffle. The cylindrical baffle may define one or more coolant outlet holes.

A stator for an electric motor includes a magnetically conductive core, electrically conductive windings, and a terminal connector. The magnetically conductive core has a plurality of poles. The electrically conductive windings encircle the poles and include end windings that extend beyond an end of the core. The terminal connector has a cylindrical baffle encircling the end windings and a frame extending radially inwardly from the cylindrical baffle adjacent to the windings. The cylindrical baffle and the frame may be made of plastic. A plurality of conductive terminals are fixed to the frame. For example, three terminals may be molded into the frame. Each of the terminals is electrically connected to the end windings and has a power link extending from the terminal connector. The power links may extend radially outside the cylindrical baffle. A coolant inlet port may extend from the frame of the terminal connector and to direct a liquid coolant onto the end windings. The cylindrical baffle may define one or more coolant outlet holes.

A vehicle includes a stator, an inverter, and a terminal connector. The stator has a magnetically conductive core and electrically conductive windings. The windings including end windings that extend beyond an end of the core. The inverter converts DC power from a battery to three phases of AC power. The terminal connector has a cylindrical baffle encircling the end windings, a frame extending radially inwardly from the cylindrical baffle adjacent to the windings, and a plurality of conductive terminals molded into the frame. The cylindrical baffle and the frame may be made of plastic. Each of the terminals is electrically connected to the end windings and receives one of the three phases of AC power. The terminals may be connected to the AC power via power links which extend radially outside the cylindrical baffle. A coolant inlet port may extend from the frame of the terminal connector to direct a liquid coolant onto the end windings. The cylindrical baffle may define one or more coolant outlet holes.

### BRIEF DESCRIPTION OF THE DRAWINGS

FIG. 1 illustrates a block diagram of an electric vehicle.

FIG. 2 illustrates a schematic diagram of components of an electric drive system of the electric vehicle, the components of the electric drive system including a traction battery, a power electronics module having a DC-link capacitor and an inverter, and a motor.

FIGS. 3 and 4 illustrate a stator with a molded terminal connector suitable for use in the electric vehicle of FIG. 1 with the electric drive system of FIG. 2.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

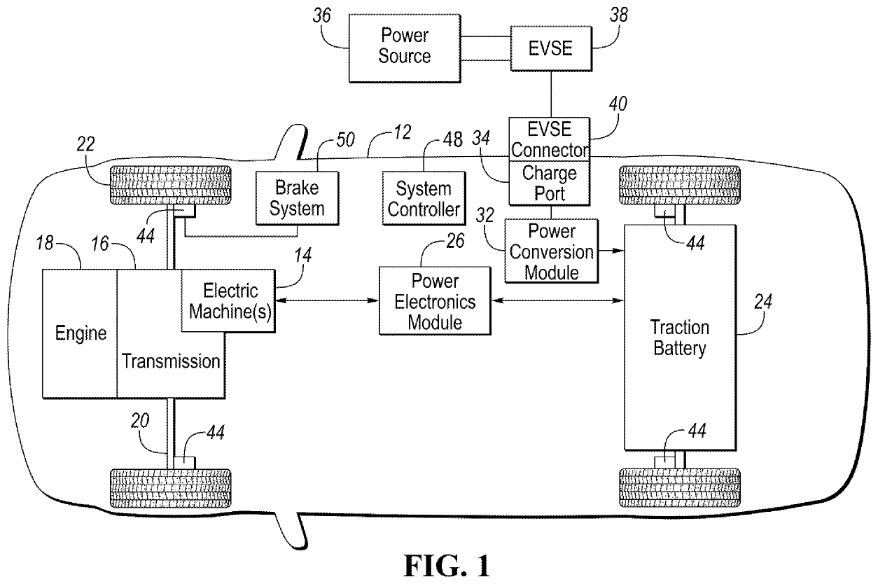

Referring now to FIG. 1, a block diagram of an exemplary electric vehicle (“EV”) 12 is shown. In this example, EV 12 is a plug-in hybrid electric vehicle (PHEV). EV 12 includes one or more electric machines 14 (“e-machines”) mechanically connected to a transmission 16. Electric machine 14 is capable of operating as a motor and as a generator. Transmission 16 is mechanically connected to an engine 18 and to a drive shaft 20 mechanically connected to wheels 22. Electric machine 14 can provide propulsion and slowing capability while engine 18 is turned on or off. Electric machine 14 acting as a generator can recover energy that may normally be lost as heat in a friction braking system. Electric machine 14 may reduce vehicle emissions by allowing engine 18 to operate at more efficient speeds and allowing EV 12 to be operated in electric mode with engine 18 off under certain conditions.

A traction battery 24 (“battery) stores energy that can be used by electric machine 14 for propelling EV 12. Battery 24 typically provides a high-voltage (HV) direct current (DC) output. Battery 24 is electrically connected to a power electronics module 26. Power electronics module 26 is electrically connected to electric machine 14 and provides the ability to bi-directionally transfer energy between battery 24 and the electric machine. For example, battery 24 may provide a direct DC voltage while electric machine 14 may require a three-phase alternating current (AC) voltage to function. Power electronics module 26 may convert the DC voltage to a three-phase AC voltage to operate electric machine 14. In a regenerative mode, power electronics module 26 may convert three-phase AC voltage from electric machine 14 acting as a generator to DC voltage compatible with battery 24.

Battery 24 is rechargeable by an external power source 36 (e.g., the grid). Electric vehicle supply equipment (EVSE) 38 is connected to external power source 36. EVSE 38 provides circuitry and controls to control and manage the transfer of energy between external power source 36 and EV 12. External power source 36 may provide DC or AC electric power to EVSE 38. EVSE 38 may have a charge connector 40 for plugging into a charge port 34 of EV 12. Charge port 34 may be any type of port configured to transfer power from EVSE 38 to EV 12. A power conversion module 32 of EV 12 may condition power supplied from EVSE 38 to provide the proper voltage and current levels to battery 24. Power conversion module 32 may interface with EVSE 38 to coordinate the delivery of power to battery 24. Alternatively, various components described as being electrically connected may transfer power using a wireless inductive coupling.

Wheel brakes 44 are provided for slowing and preventing motion of EV 12. Wheel brakes 44 are part of a brake system 50. Brake system 50 may include a controller to monitor and control wheel brakes 44 to achieve desired operation.

The various components discussed may have one or more associated controllers to control and monitor the operation of the components. The controllers can be microprocessor-based devices. The controllers may communicate via a serial bus (e.g., Controller Area Network (CAN)) or via discrete conductors. For example, a system controller 48 (i.e., a vehicle controller) is present to coordinate the operation of the various components.

As described, EV 12 is in this example is a PHEV having engine 18 and battery 24. In other embodiments, EV 12 is a battery electric vehicle (BEV). In a BEV configuration, EV 12 does not include an engine.

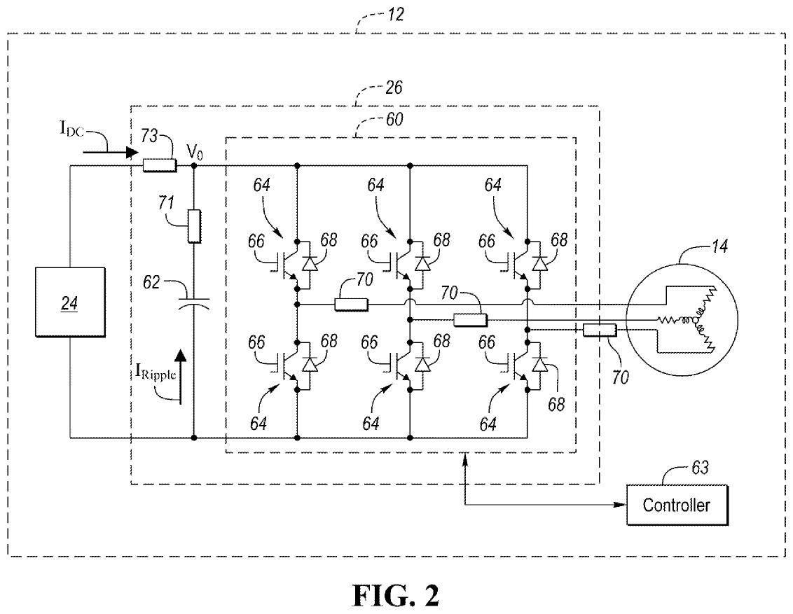

Referring now to FIG. 2, with continual reference to FIG. 1, a schematic diagram of components of an electric drive system of EV 12 is shown. As shown in FIG. 2, the electric drive system of EV 12 includes traction battery 24, power electronics module 26, and electric machine (i.e., “motor”) 14.

As described above, power electronics module 26 is coupled between battery 24 and motor 14. Power electronics module 26 converts DC electrical power provided from battery 24 into AC electrical power for providing to motor 14. In this way, power electronics module 26 drives motor 14 with power from battery 24 for the motor to propel EV 12.

Power electronics module 26 includes a DC-link capacitor 62 and an inverter 60 (or “inverter control system” (“ICS”)). Inverter 60 shown in FIG. 2 is an exemplary inverter. DC-link capacitor 62 is disposed between battery 24 and inverter 60 and is connected in parallel with battery 24. DC-link capacitor 62 is operable to absorb ripple currents generated by operation of power switches of inverter 60 and stabilize a DC-link voltage Vo for inverter 60 control.

As known to those of ordinary skill, inverters convert DC power to multi-phase AC power (three-phase being most common). Inverters can move electrical power in either direction (bi-directional) either driving an electric machine (i.e., motoring) or electrically braking the electric machine (i.e., generating). An inverter system is made up of a combination of power electronic hardware (switches) and control software (FIG. 2 is a representative drawing). Electrical current can be quickly adjusted by opening and closing the power switches in the inverter.

Many inverter systems, including inverters relevant to embodiments of the present disclosure such as inverter 60, perform closed loop current control to precisely control the e-machine. To achieve this, the electric current in each phase of the inverter is sensed with a current sensor and a corresponding signal is provided to the controller of the inverter system. The most common approach is to sense all of the phases, but any one phase current can be inferred from knowledge of the other phase currents. The current sensor can use and/or be implemented in different technologies and current sensors 70 shown in FIG. 2, discussed below, are but one example. Such current sensors are typically integrated into the inverter.

Inverter 60 includes inverting circuitry and a plurality of power switching units 64. As known to those of ordinary skill, in the exemplary example, inverter 60 includes three sets of pairs of power switching units 64 (i.e., three×two=a total of six power switching units 64 as shown in FIG. 2). Each pair of power switching units 64 includes two power switching units 64 connected in series. Each power switching unit 64 includes a power switch 66, in the form a transistor, arranged anti-parallel with a diode 68. In this example, the transistor is an insulated gate bipolar transistor (IGBT). Each pair of power switching units 64 is connected in parallel with battery 24 and DC-link capacitor 62 and thereby each pair of power switching units forms a “phase” of inverter 60. In this way, inverter 60, having three pairs of power switching units 64, is a three-phase inverter operable for converting DC electrical power from battery 24 into three-phase AC electrical power for provision to motor 14.

Further, each phase of inverter 60 includes a current sensor 70. For instance, each current sensor 70 is a resistive shunt connected in series with the output of the corresponding phase. Current sensors 70 are operable for sensing the electrical current (IAC) outputted from the corresponding phases of inverter 60 to motor 14.

Further, a current sensor 71 is associated with DC-link capacitor 62. For instance, current sensor 71 is a resistive shunt connected in series with DC-link capacitor 62. Current sensor 71 is operable for sensing an electrical ripple current (I_{Ripple}) of DC-link capacitor 62. Alternatively, the electrical ripple current (I_{Ripple}) of DC-link capacitor 62 is calculated based on various operating parameters.

Further, a current sensor 73 is associated with the input of inverter 60. For instance, current sensor 73 is a resistive shunt connected in series with the input of inverter 60 (i.e., extending towards inverter 60 from the node at which traction battery 24, DC-link capacitor 62, and inverter 60 are connected). Current sensor 73 is operable for sensing an electrical input DC current (IDC) drawn by inverter 60.

Power electronics module 26 has an associated controller 63. Controller 63 can be a microprocessor-based device. Controller 63 is configured to monitor operation of DC-link capacitor 62 and to monitor and control operation of inverter 60. Particularly, controller 63 is operable to control the operation of power switches 66 to cause inverter 60 to convert a given DC electrical power provided from battery 24 via DC-link capacitor 62 into a desired AC electrical power for providing to motor 14. Controller 63 is in communication with current sensors 70 to monitor the AC electrical power provided from inverter 60 to motor 14. Controller 63 uses information of current sensors 70 as feedback in controlling inverter 60 to output the desired AC electrical power to motor 14.

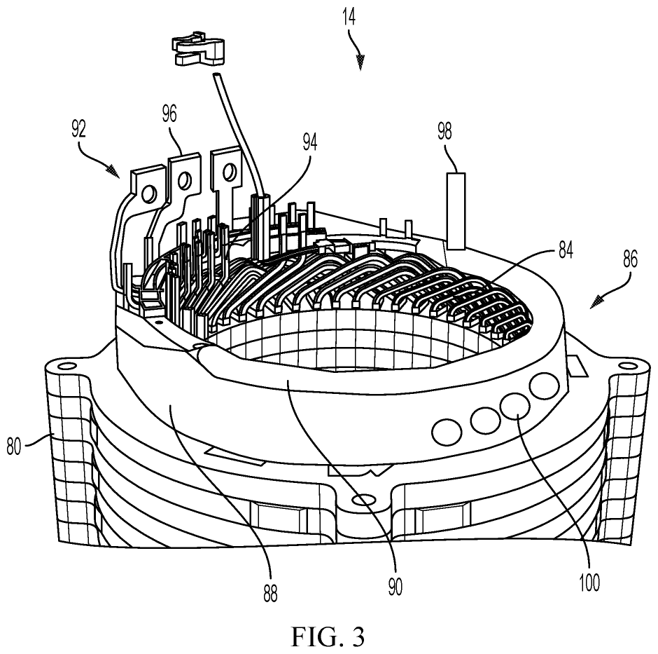

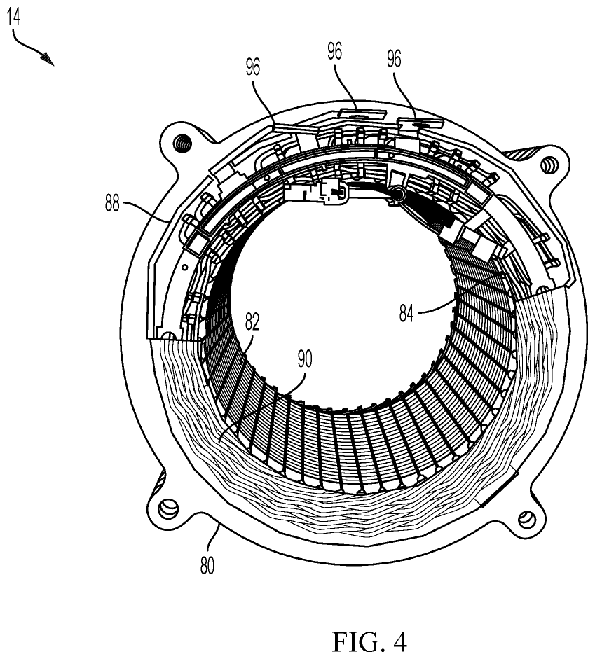

FIGS. 3 and 4 show a stator of motor 14. The stator includes a magnetically conductive core 80. The core 80 is cylindrical with a set of poles 82 protruding inwardly. Three sets of electrically conductive windings encircle each of the poles, one for each of the three phases of the motor. The windings include end windings 84 which extend beyond the end of the core. A molded terminal connector 86 fits around the end windings and provides an electrical connection point to the inverter 60. The terminal connector includes a cylindrical portion 88 (not necessarily a circular cylinder) and a frame 90 which extends inwardly from an end of the cylindrical portion. The cylindrical portion and the frame may integrally formed from a non-conductive material such as plastic via a process such as injection molding. Three electrically conductive terminals 92 are fixed to the frame such as by being molded into the frame. Each of the terminals includes a winding link 94 extending from the frame toward the end windings. Each winding link is electrically connected to an end winding such as by welding. Each of the terminals also includes a power link 96 for connection to the inverter. The terminal links may extend radially outwardly from the cylindrical portion. A coolant inlet port 98 extends from the frame such that liquid coolant may be injected onto the end windings. The cylindrical portion includes a number of holes 100 for the coolant to exit.

The molded terminal connector 86 of FIGS. 3 and 4 serves the functions of a terminal connector and also of a baffle using a single part. In addition to the financial savings associated with having fewer parts, this integrated design offers multiple advantages over having separate parts for these functions. A separate baffle would need to have a larger average diameter than the cylindrical portion 88 to fit around the power links 96 during assembly. Thus, it would not fit as closely to the end windings and would not be as effective at routing cooling fluid over the end windings. With the integrated design, the power links 96 can extend further outward which simplifies making the required electrical connections after the stator is installed in the transmission housing. Once the molded terminal connector is installed on the stator, it provides mechanical protection for the end windings making contact with to the end windings during handling and assembly less likely.

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. A terminal connector for an electric motor, the terminal connector comprising:
a cylindrical baffle;
a non-conductive frame extending radially inwardly from a first end of the cylindrical baffle; and
a plurality of electrically conductive terminals fixed to the frame, each of the terminals having a winding link extending toward a second end of the cylindrical baffle and a power link extending radially outwardly from the cylindrical baffle, the terminals being electrically isolated from one another.

2. The terminal connector of claim 1 further comprising a coolant inlet port extending from the frame and configured to direct a liquid coolant into an interior of the cylindrical baffle.

3. The terminal connector of claim 2 wherein the cylindrical baffle defines one or more coolant outlet holes.

4. The terminal connector of claim 1 wherein the cylindrical baffle and the frame are made of plastic.

5. The terminal connector of claim 4 wherein the plurality of conductive terminals are molded into the frame.

6. The terminal connector of claim 1 wherein the plurality of conductive terminals comprises three terminals.

7. A stator for an electric motor, the stator comprising:
a magnetically conductive core having a plurality of poles;
electrically conductive windings encircling the poles, the windings including end windings that extend beyond an end of the core; and
a terminal connector having a cylindrical baffle encircling the end windings, a frame extending radially inwardly from the cylindrical baffle adjacent to the windings, and a plurality of conductive terminals fixed to the frame, each of the terminals electrically connected to the end windings and having a power link extending from the terminal connector.

8. The stator of claim 7 further comprising a coolant inlet port extending from the frame of the terminal connector and configured to direct a liquid coolant onto the end windings.

9. The stator of claim 8 wherein the cylindrical baffle defines one or more coolant outlet holes.

10. The stator of claim 7 wherein the cylindrical baffle and the frame are made of plastic.

11. The terminal connector of claim 10 wherein the plurality of conductive terminals are molded into the frame.

12. The stator of claim 7 wherein the plurality of conductive terminals comprises three terminals.

13. The stator of claim 7 wherein the power links extend radially outside the cylindrical baffle.

14. A vehicle comprising:
a stator having a magnetically conductive core and electrically conductive windings, the windings including end windings that extend beyond an end of the core;
an inverter configured to convert DC power from a battery to three phases of AC power; and
a terminal connector having a cylindrical baffle encircling the end windings, a frame extending radially inwardly from the cylindrical baffle adjacent to the windings, and a plurality of conductive terminals molded into the frame, each of the terminals electrically connected to the end windings and receives one of the three phases of AC power.

15. The vehicle of claim 14 further comprising a coolant inlet port extending from the frame of the terminal connector and configured to direct a liquid coolant onto the end windings.

16. The vehicle of claim 15 wherein the cylindrical baffle defines one or more coolant outlet holes.

17. The vehicle of claim 14 wherein the cylindrical baffle and the frame are made of plastic.

18. The vehicle of claim 14 wherein the terminals are connected to the AC power via power links which extend radially outside the cylindrical baffle.
